(19) United States
(12) Patent Application Publication
(10) Pub. No.: US 2010/0226064 A1
(43) Pub. Date: Sep. 9, 2010

(54) Trimmable Transformer Arrangement

(76) Inventors: Roderick McConnell, Muenchen (DE); Bernhard Strzalkowski, Muenchen (DE)

Correspondence Address: SLATER & MATSIL, L.L.P., 17950 PRESTON ROAD, SUITE 1000, DALLAS, TX, 75252, US

(21) Appl. No.: 12/400,141

(22) Filed: Mar. 9, 2009

(51) Int. Cl. H01F 5/04

(52) U.S. Cl. 361/270

(57) ABSTRACT

A circuit arrangement includes a coreless transformer. A trimming device is connected to the transformer and includes a variable capacitance and/or inductance.

### BACKGROUND

Coreless transformers are transformers that do not have a transformer core. Such coreless transformers can be integrated in or on a semiconductor chip or on a printed circuit board (PCB). These transformers can, therefore, be realized in a space-saving manner. Such transformers can be used in circuit applications in which data or electrical energy is to be transmitted across a potential barrier between two circuits that have different reference potentials. Such a circuit is, for example, a gate drive circuit of a high-side power semiconductor switch, like a MOSFET or an IGBT.

Coreless transformers have a maximum impedance frequency (MIF), which is the frequency for which the transformer has its highest input impedance, and have a maximum efficiency frequency (MEF), which is the frequency for which the transformer has its lowest transmission losses. In particular, when power is to be transmitted using a coreless transformer it is desired to operate the transformer at its, or at least close to its MEF. For a given load scenario MEF and MIF are different from each other, with a difference between MEF and MIF becoming larger with increasing load current.

Transmission properties of a coreless transformer and, therefore, MEF and MIF depend on a number of electrical parameters which, inter alia, include: inductivities of the transformer's primary and secondary windings; ohmic resistances of the transformer's primary and secondary windings; input and output capacitances of the transformer; and an inductive coupling between the transformer's primary and secondary windings. These parameters, due to process variations, may vary even for those transformers that are produced using identical process steps.

### SUMMARY OF THE INVENTION

One aspect of the present disclosure relates to a circuit arrangement that includes: a transformer having a first winding and a second winding. A trimming device is connected to one of the first and second windings and includes at least one of a variable capacitive component and a variable inductive component.

A further aspect relates to a method for signal or power transmission through a circuit arrangement that includes: input terminals and a coreless transformer having a first winding and a second winding. A trimming device is connected to one of the first and second windings and includes at least one of a variable capacitive component and/or a variable inductive component. The circuit arrangement has a maximum efficiency frequency (MEF) and a maximum impedance frequency (MIF) that is dependent on one of capacitance or inductance. In the method, an input signal that has an input frequency is applied to the input terminals. One of the MEF and MIF of the circuit arrangement is adjusted to be equal to the input frequency or differ from the input frequency for less than a given frequency difference by adjusting at least one of the adjustable capacity and the variable inductivity.

### BRIEF DESCRIPTION OF THE DRAWINGS

Examples will now be explained with reference to the drawings. The drawings serve to explain the basic concept. Therefore, only those aspects required for explaining this basic concept are shown in the figures. In the figures, unless stated otherwise, same reference signs denote the same features with the same meaning.

FIG. 1 illustrates a circuit diagram of a transformer arrangement that has a coreless transformer and a trimming circuit connected to a primary winding of the coreless transformer;

FIG. 2 illustrates a circuit diagram of a transformer arrangement that has a coreless transformer and a trimming circuit connected to a secondary winding of the coreless transformer;

FIG. 3 illustrates an equivalent circuit diagram of a coreless transformer;

FIG. 4 illustrates a first example of the trimming circuit;

FIG. 5 illustrates a method for an MEF trimming procedure;

FIG. 6 illustrates a third example of the trimming circuit;

FIG. 7 illustrates a control circuit of the trimming circuit for measuring the load condition and generating trimming signals;

FIG. 8 illustrates a circuit diagram of a transformer arrangement that is capable of being adapted during its operation; and

FIG. 9 illustrates a circuit diagram of a transformer arrangement that has an adjustable oscillator.

### DETAILED DESCRIPTION OF ILLUSTRATIVE EMBODIMENTS

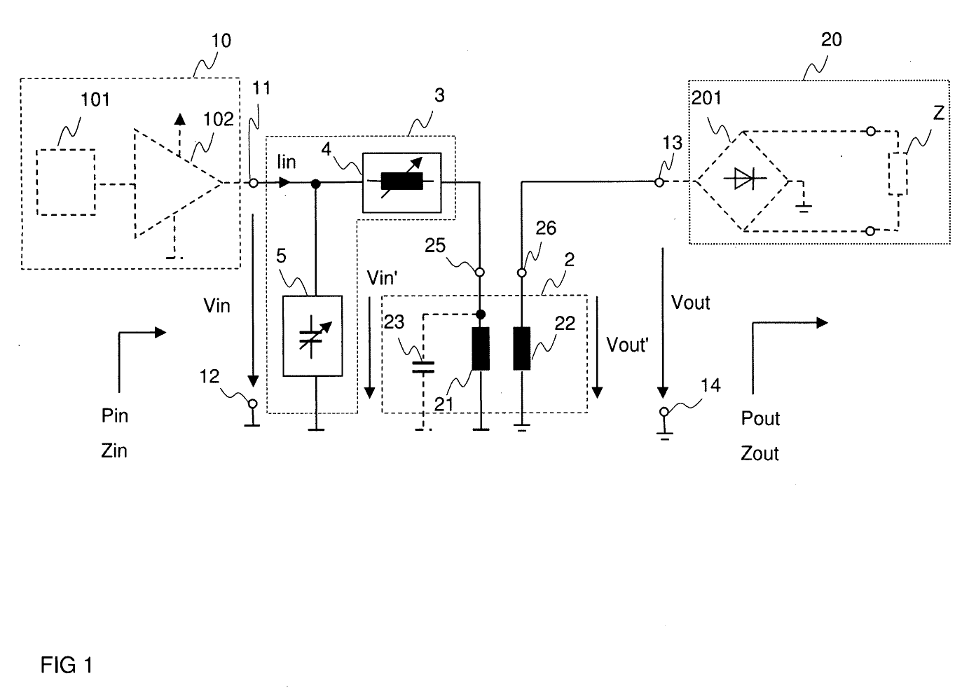

FIG. 1 illustrates a first example of a transformer arrangement by way of a circuit diagram. The transformer arrangement includes a coreless transformer 2 having a primary winding 21 and a secondary winding 22 that are inductively coupled to each other. Primary winding 21 has a parasitic capacitance 23 that lies parallel to primary winding 21. Such parasitic capacitance 23 is shown in dashed lines in FIG. 1 and has reference number 23.

Coreless transformer 2 may be any kind of coreless transformer, including a coreless transformer having its primary and secondary windings disposed on a printed circuit board (PCB), or a coreless transformer having its primary and secondary windings integrated in or disposed on a semiconductor chip. The transformer arrangement further comprises input terminals 11, 12 for applying an input voltage Vin, and output terminals 13, 14 for providing an output voltage Vout. One of the input terminals, e.g., second input terminal 12 in the example according to FIG. 1, is connected to a terminal for a first reference potential, which will be referred to as primary-side reference potential in the following. One of the output terminals, e.g., the second output terminal 14 in the example according to FIG. 1, is connected to a terminal for a second reference potential, which will be referred to as secondary-side reference potential in the following.

The transformer arrangement further comprises a trimming circuit 3 that is connected between input terminals 11, 12 and primary winding 21. Trimming circuit 3 includes at least one of: an adjustable inductance unit 4 that has an adjustable inductivity and that is connected in series to primary winding 21; and an adjustable capacitance unit 5 that has an adjustable capacity and that is connected in parallel to primary winding 21. Adjustable capacitance unit 5 may be connected (as shown) in parallel to a series circuit comprising adjustable inductance unit 4 and primary winding 21. Alternatively adjustable capacitance unit 5 may also be connected parallel to primary winding 21, even in those cases in which the transformer arrangement includes adjustable inductance unit 4. It should be noted that the transformer arrangement may include both, adjustable inductance unit 4 and adjustable capacitance unit 5, or only one of these adjustable units 4, 5.

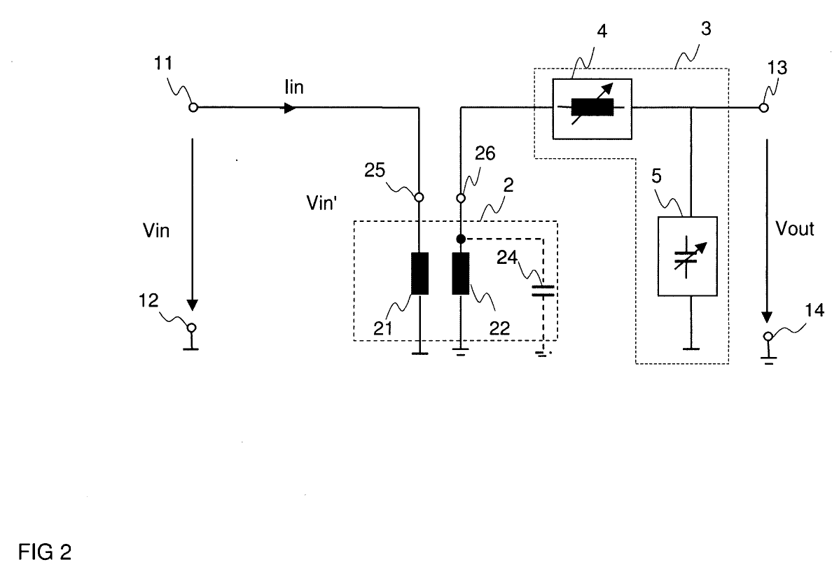

Referring to FIG. 2 trimming circuit 3 may also be connected between secondary winding 22 and output terminals 13, 14. Reference number 24 in FIG. 2 denotes a parasitic capacitance of secondary winding 22. Adjustable inductance unit 4 is in this case connected in series to secondary winding 22, and adjustable capacitance unit 5 is (as shown) connected parallel to the series circuit with secondary winding 22 and adjustable inductance unit 4. Alternatively adjustable capacitance unit 5 may be connected only in parallel to secondary winding 22, even in those cases in which the transformer arrangement comprises an adjustable inductance unit 4.

Referring to FIG. 1 the transformer arrangement is adapted to have a driver circuit 10 (shown in dashed lines) connected to its input terminals 11, 12, and to have a load circuit 20 connected to its output terminals 13, 14. During operation of the transformer arrangement driver circuit 10 generates an input voltage Vin at the input terminals 11, 12 of the transformer arrangement from which the transformer arrangement generates an output voltage Vout at its output terminals 13, 14. The input voltage Vin is an oscillating or alternating voltage. Accordingly, the output voltage Vout is an oscillating or alternating voltage.

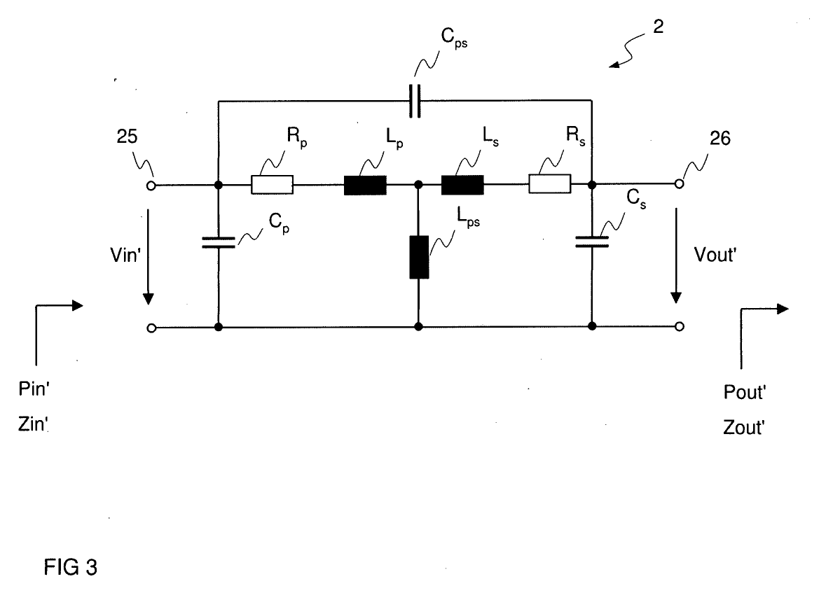

Referring to FIG. 3 coreless transformer 2 may be described by way of an equivalent circuit diagram. In this equivalent circuit diagram Vin′ is a voltage applied to the primary winding 21, and Vout′ is a voltage resulting from input voltage Vin′ across secondary winding 22. These voltages are also shown in FIG. 1. FIG. 3 shows the equivalent circuit diagram for the specific case in which a primary reference potential corresponds to a secondary reference potential. An equivalent circuit diagram for a more general case in which these reference potentials are different, corresponds to the circuit diagram of FIG. 3 and additionally includes an ideal transformer (not shown) connected to either the input terminals or the output terminals of the diagram in FIG. 3. Reference numbers 25 and 26 in FIG. 3 denote input and output terminals of the coreless transformers. These terminals are also shown in FIG. 1.

Referring to the equivalent circuit diagram of FIG. 3 electrical characteristics of the coreless transformers 2 depend on the following: an input capacitance Cₚ that is connected parallel to the input terminals of coreless transformers 2; an output capacitance C_{S} that is connected between the output terminals of coreless transformer 2; a coupling capacitance Cₚₛ that is connected between one of the input terminals and one of the output terminals of coreless transformer 2; ohmic resistance Rₚ of primary winding 21; a primary leakage inductance Lₚ; a secondary leakage inductance Lₛ; an ohmic resistance Rₛ of secondary winding; and a primary mutual inductance Lₚₐ. These electrical parameters define the electrical characteristics of coreless transformer 2. These electrical characteristics, for example, are: an input impedance Zin′, with:

$${Zin}^{′} = \vert \frac{{Vin}^{′}}{{Iin}^{′}} \vert , \qquad ( 1 )$$

wherein Vin′ is an input voltage and Iin′ is an input current resulting from the input voltage Vin′; input power Pin′ with:

Pin′=Vin′·Iin′ (2),

output resistance Zout′ with:

$${Zout}^{′} = \vert \frac{{Vout}^{′}}{{Iout}^{′}} \vert , \qquad ( 3 )$$

wherein Vout′ is an output voltage and lout′ is an output current; or output power Pout′ with:

Pout′=Vout′·Iout′ (4).

A further important electrical characteristic of coreless transformer 2 is its power efficiency η that is given by:

$$η = \frac{{Pout}^{′}}{{Pin}^{′}} . \qquad ( 5 )$$

Further electrical characteristics of coreless transformer 2 are its maximum impedance frequency (MIF) and its maximum efficiency frequency (MEF). The maximum impedance frequency is the frequency of input voltage Vin′ for which input impedance Zin′ of coreless transformer 2 reaches its maximum. The maximum efficiency frequency is the frequency of the input voltage Vin′ of coreless transformer 2 for which power transfer efficiency l reaches its maximum. In this connection it should be mentioned that MIF and MEF depend on the load that is connected to the output terminals of coreless transformer 2.

The electrical characteristics of different coreless transformers that are produced using identical process steps may vary due to process variations. Trimming circuit 3 that, referring to FIGS. 1 and 2, is either connected to primary winding 21 or to secondary winding 22 serves to compensate for such variations in the electrical characteristics of the coreless transformer 2.

Referring to FIG. 1, input and output resistances Zin, Zout with:

$$\begin{matrix}Zin = \frac{Vin}{Iin} , \\ and & ( 6 ) \\ Zout = \frac{Vout}{Iout} , & ( 7 )\end{matrix}$$

and input and output power Pin, Pout with:

Pin=Vin·Iin (8),

Pout=Vout·Iout (9),

may be defined for the transformer arrangement. Further, the transformer arrangement as a whole, like the coreless transformer 2, has a maximum impedance frequency (MIF) and a maximum efficiency frequency (MEF).

In one example trimming circuit 3 serves to compensate for variations in the electrical characteristics of coreless transformer 2 in order to set the MIF or the MEF of the transformer arrangement to a given frequency value or at least close to a given frequency value. This given frequency value is, for example, the frequency of the input voltage Vin provided by driver stage 10. Setting MEF or MIF “close to a given frequency” means that MEF or MIF differs less than a given frequency difference from the given frequency. This difference is, for example, less than about 10% or less than about 5% of the given frequency.

Trimming circuit 3 is adapted to adjust the electrical characteristic of the transformer arrangement having a coreless transformer 2. Transformer arrangements that have coreless transformers 2 with different electrical characteristics can, using the trimming circuit 3, be adjusted to have identical or almost identical electrical characteristics and can therefore be driven using identical driver stages 10. If trimming circuit 3 trims the transformer arrangement to have either its MIF or to have its MEF at the given frequency is dependent on a specific application of the transformer arrangement. In applications in which the transformer arrangement serves to transfer power, trimming circuit 3 may adjust the MEF to the given frequency; and in applications in which the transformer arrangement is used to transmit information as well as in applications in which the input impedance should be as high as possible, trimming circuit 3 adjusts the MIF of the transformer arrangement to the given frequency value.

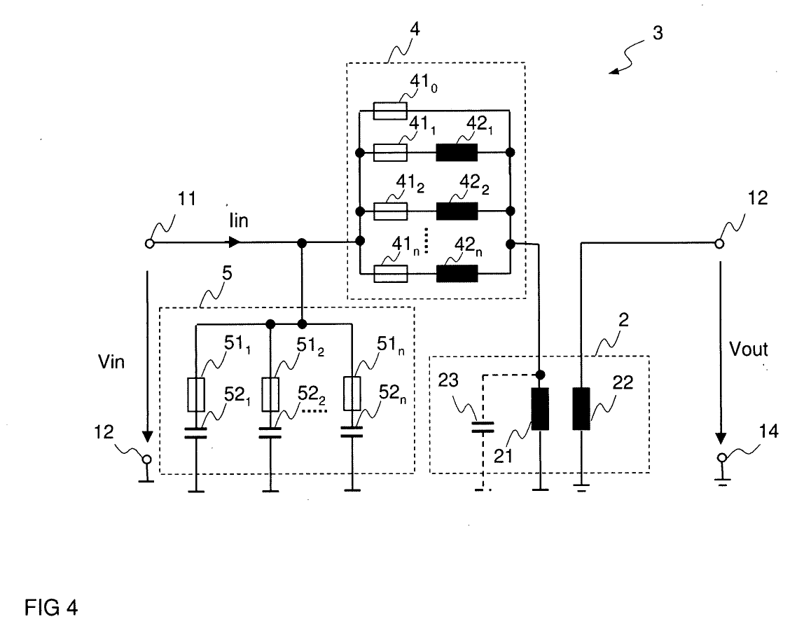

Examples of methods for trimming the MIF or MEF of a transformer arrangement to a given frequency value using trimming circuit 3 will now be explained with reference to further figures. In a first method the electrical characteristics of the transformer arrangement are set during manufacturing or at the end of manufacturing the transformer arrangement. FIG. 4 illustrates examples of adjustable inductance and adjustable capacitance circuits 4, 5 that are suitable for setting electrical characteristics of the transformer arrangement during manufacturing or at the end of manufacturing. The adjustable inductance circuit 4 according to this example includes a number of series circuits each of which comprising an inductance 42₁, 42₂, 42ₙ and a fuse 41₁, 41₂, 41ₙ, A further fuse 41₀ directly connects input terminal 11 and primary winding 21. The adjustable inductance circuit 4 has its lowest inductance in case further fuse 41₀ is conducting. The fuses 41₀-41ₙ may be any kind of fuses, in particular, fuses that can be manufactured with processes that are used for producing semiconductor components. The overall inductance of adjustable inductance circuit 4 can be set by selectively melting the fuses during manufacturing or at the end of manufacturing of the transformer arrangement.

Adjustable capacitance circuit 5 has a number of series circuits each of which comprising a capacitance 52₁, 52₂, 52ₙ that is connected in series to a fuse 51₁, 51₂, 51ₙ, the series circuits being connected in parallel to each other. The overall capacitance of adjustable capacitance circuit 5 is set by selectively melting the fuses 51₁, 51₂, 51ₙ during manufacturing or at the end of manufacturing the transformer arrangement.

The overall inductance of adjustable inductance circuit 4 and/or the overall capacitance of adjustable capacitance circuit 5 influence the electrical characteristics of the transformer arrangement. To determine the inductance value and/or the capacitance value that have to be set for adjustable inductance circuit 4 and/or adjustable capacitance circuit 5 the electrical characteristics of coreless transformer 2 are measured at the end of the manufacturing process. For example, the MEF and the MIF of coreless transformer 2 is evaluated. Further, a difference between the measured MIF or MEF of coreless transformer 2 and a desired MEF or MIF of the transformer arrangement is determined and the inductance value of adjustable inductance 4 and/or the capacitance value of adjustable capacitance value 5 are selected so as to compensate for this difference, wherein MEF or MIF of the transformer arrangement corresponds to MEF or MIF of coreless transformer 2, if fuse 41₀ of inductance circuit 4 is conducting, and if all fuses 51₁-51ₙ of capacitance circuit 5 have been melted or blown.

MEF and MIF of coreless transformer 2 due to process variations may vary. In one example a maximum variation of this MEF or MIF is defined, where coreless transformers 2 having a MEF or MIF being outside this defined range will be discarded. For MEF values or MIF values that are within this given range settings for inductance circuit 4 and/or capacitance circuit 5 that are required to set MIF or MEF of the transformer arrangement to a given value can be obtained by simulations or tests. Using such simulations or tests a look-up table can be generated that to each MIF or MEF value, that is within the given range, assigns setting parameters for inductance circuit 4 and/or capacitance circuit 5. These setting parameters indicate the fuses of inductance circuit 4 and/or capacitance circuit 5 that have to be melted or blown in order to obtain the desired MEF or MIF of the transformer arrangement. In this connection it should be mentioned that either fuses that conduct in their activated state, or fuses that electrically isolate in their activated state may be used in inductance circuit 4 and/or capacitance circuit 5.

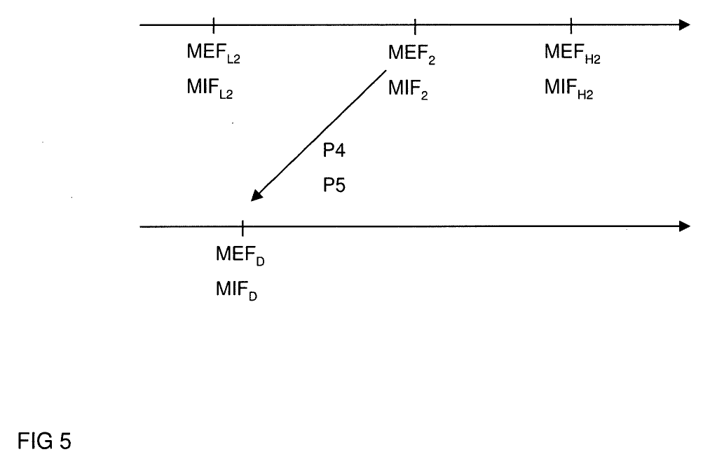

A method for setting MEF/MIF of the transformer arrangement to a desired value MEF_{D}/MIF_{D} is illustrated in FIG. 5. MEF₂, MIF₂ denote measured MEF/MIF values of coreless transformer 2. P4, P5 are setting parameters of inductance circuit 4 and capacitance circuit 5 that considering the measured MEF/MIF values are used for setting MEF/MIF of the transformer arrangement to the desired value MEF_{D}/MIF_{D}. MEF_{2L}/MIF_{2L} and MEF_{2H}/MIF_{2H} denote lower and upper borders of the MEF/MIF range of coreless transformer 2. For a number of MEF/MIF values of this range setting parameters P4, P5 have been obtained by simulations or tests.

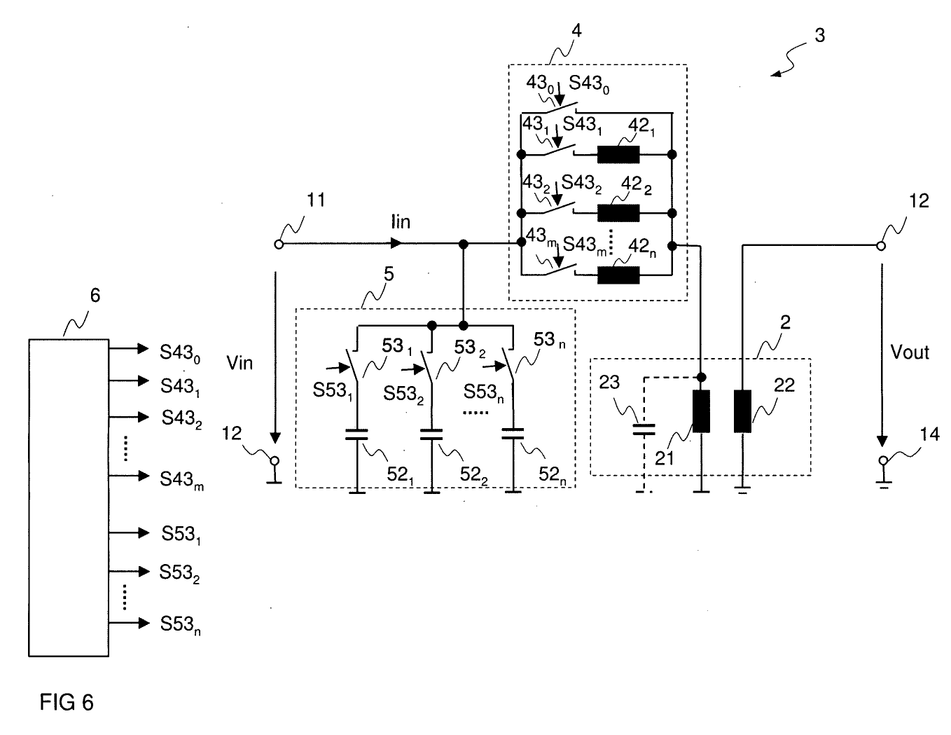

FIG. 6 illustrates an example of a transformer arrangement in which instead of fuses, switches 43₁, 43₂, 43ₘ are connected in series to inductances 42₁-42ₙ of inductance circuit 4. Further, a switch 43₀ is connected between input terminal 11 and primary winding 21. Similarly, instead of fuses, switches 53₁, 53₂, 53ₙ are connected in series to capacitance 52₁, 52₂, 52ₙ of capacitance circuit 5. Each of these switches receives a control signal S43₀-S43_{m,} S53₁-S53ₙ. These control signals have one of either an on-level or off-level, an on-level of a control signal switching on the respective switch that receives the control signal, and an off-level of the control signal switches the respective switch off. A control circuit 6 generates these control signals S43₀-S43ₘ, S53₁-S53ₙ. The signal levels of control signals S43₀-S43ₘ form a set of parameters P4 for adjusting the inductivity of inductance circuit 4, and the signal levels of control signals S53₁-S53ₙ form a set of parameters P5 for adjusting the capacity of capacitance circuit 5. The functionality of inductance and capacitance circuits 4, 5 of FIG. 6 correspond to the functionality of inductance and capacitance circuits 4, 5 of FIG. 5 with the difference that the inductivity and the capacity of inductance and capacitance circuit 4, 5 are set electrically using the control signals.

It should be mentioned that for both types of explained inductance and capacitance circuits 4, 5 the different inductances 42₁, 42₂, 42ₙ and the different capacities 52₁, 52₂, 52ₙ may have the same inductivities and capacities. In this case the overall inductivity of inductance circuit 4 and the overall capacity of capacitance circuit 5 is set by the number of inductances and capacitances that are connected in parallel. In another example the inductances and capacitances have different inductivities and capacities. In this case the overall inductivity of inductance circuit 4 and the overall capacity of capacitance circuit 5 can be set by either activating only one of these inductances/capacitances or by activating two or more inductances/capacitances.

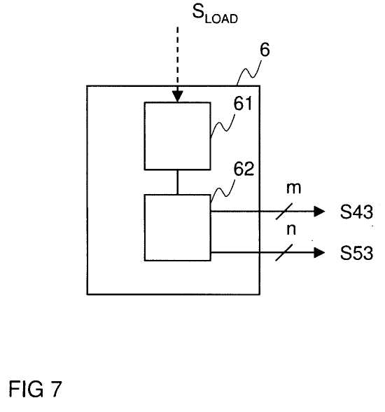

Referring to FIG. 7 control circuit 6 may comprise a programmable circuit 61, like an EPROM, or an EEPROM. Control circuit 6 further comprises a driver circuit 62 that is connected to programmable circuit 61 and that is adapted to read parameters stored in the programmable circuit 61 and to generate the control signals for inductance and capacitance circuits 4, 5 dependent on these parameters. S43, S53 in FIG. 7 denote the group of control signals provided to inductance circuit 4, and the group of control signals provided to capacitance circuit 5.

Programmable circuit 61 can be programmed at the end of the manufacturing process and after MEF/MIF of coreless transformer 2 has been measured. Programmable circuit 61 after programming holds a set of parameters. These parameters determine the overall inductivity/capacity of inductance circuit 4 and capacitance circuit 5 and correspond to the parameters P4, P5 of FIG. 5. These parameters set the overall inductivity/capacity of inductance circuit 4/capacitance circuit 5 such that, considering the measured MEF, MIF of coreless transformer 2, MEF/MIF of the transformer arrangement corresponds to the desired value MEF_{D}/MIF_{D}.

MEF and MIF of the transformer arrangement, besides MEF and MIF of coreless transformer 2 and the inductivity/capacity of inductance circuit 4 and capacitance circuit 5, depends on the load connected to output terminals 13, 14 during operation of the transformer arrangement. According to one example of a method, several sets of parameters are stored in programmable circuit 61, with each of these different sets of parameters being assigned to one particular load characteristic. Each of these parameter sets considers the measured MEF/MIF of coreless transformer 2 and is adapted to adjust the inductivity/capacity of inductance circuit 4/capacitance circuit 5 such that MEF/MIF of the transformer arrangement corresponds to a given value for a given load characteristic.

Driver circuit 62 selects one of these parameter sets for generating the control signals S43, S53 dependent on a load signal S_{LOAD}, this load signal S_{LOAD} including an information of the load characteristic of a load to be connected to output terminals 13, 14. Load signal S_{LOAD} may be generated by any suitable circuit, in particular, by a passive circuit component (not shown) connected to the input terminal of control circuit 6. Using control signal S_{LOAD} a user may adapt transformer arrangement to be used in connection with different loads having different load characteristics.

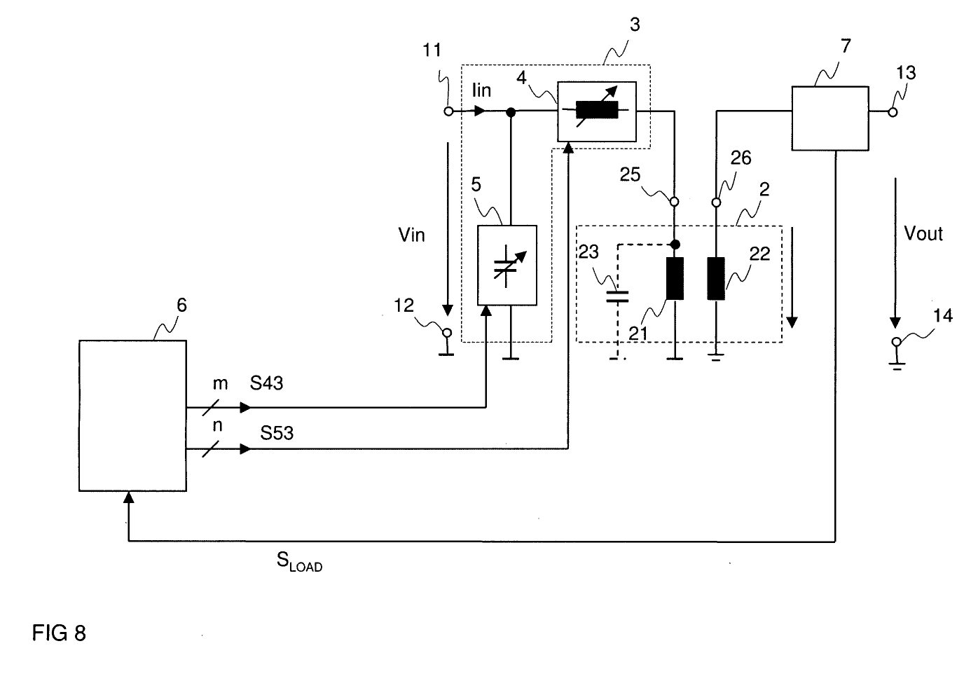

FIG. 8 illustrates another example of a method for trimming the transformer arrangement. In this example load characteristic signal S_{LOAD} is generated during operation of the transformer arrangement. This allows to adapt the transfer characteristic of the transformer arrangement to variations in the load. An evaluation circuit 7 provides load characteristic signal S_{LOAD}. Evaluation circuit 7 which is only shown schematically in FIG. 8 is adapted to evaluate the output impedance Z_{OUT} or the output power of the transformer arrangement, and is adapted to generate load characteristic signal S_{LOAD} dependent on these measured output impedance or output power values.

For determining the output power Pout the evaluation circuit 7 measures the output voltage Vout and one of the following: output current lout, i.e., the current through secondary winding 22; or the input current Iin.

In a method according to a further embodiment, MEF of the transformer arrangement or MIF of the transformer arrangement are measured, a measurement value indicating a current MEF/MIF value is provided to control circuit 6, control circuit 6 being adapted to adjust inductance circuit 4 and capacitance circuit 5 to set MEF/MIF to a given value.

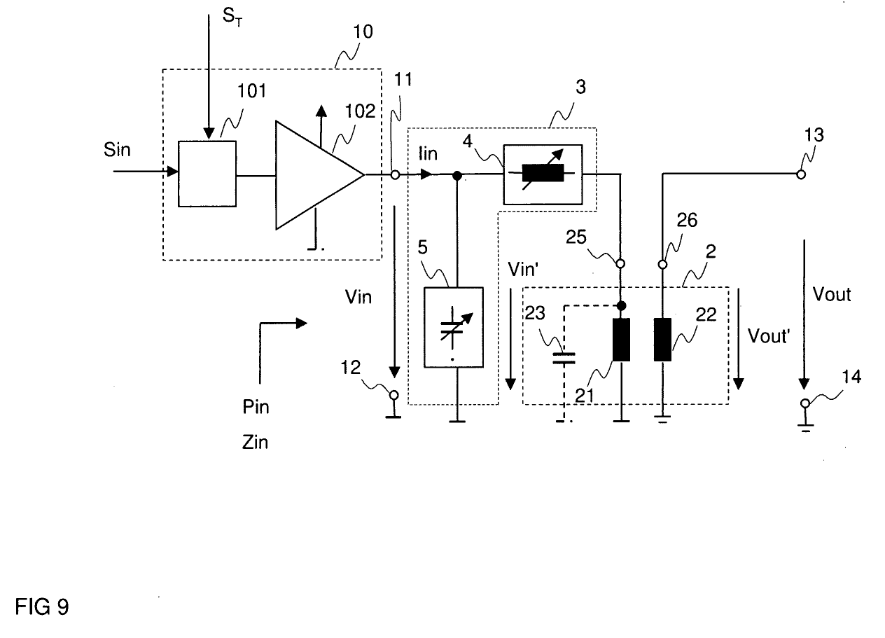

Referring to FIG. 9 alternatively providing a trimming circuit 3 or additionally providing a trimming circuit 3 the circuit arrangement may comprise a trimmable oscillator circuit 10 that receives a trimming signal S_{T} for trimming an oscillator frequency to a frequency that corresponds to MEF/MIF of the transformer arrangement. The function of trimming signal S_{T} corresponds to the function of setting signals P4, P5 that set the characteristic of adjustable inductance and capacitance circuits 4, 5. Trimming signal S_{T} may therefore be generated in an equivalent manner as these setting parameters. Oscillator circuit 10 further receives an input signal Sin that, for example, serves to activate or deactivate oscillator circuit 10. Input signal Sin may be a pulsewidth-modulated signal that is modulated in accordance with an information signal in order to transmit information via coreless transformer 2.

What is claimed is:

1. A circuit arrangement comprising:
a coreless transformer having a first winding and a second winding;
a trimming device connected to the first or the second winding, the trimming device including at least one of a variable capacitive component and/or a variable inductive component.

2. The circuit arrangement according to claim 1, wherein the trimming device comprises a variable inductive component that comprises a parallel circuit having a number of inductances that are connected in parallel and that are adapted to be activated or deactivated independently of each other, the parallel circuit being connected in series with the first or the second winding.

3. The circuit arrangement according to claim 2, further comprising an activation element connected in series with at least one of the inductances.

4. The circuit arrangement according to claim 3, wherein the activation element comprises a fuse or a switch.

5. The circuit arrangement according to claim 1, wherein the trimming device comprises a variable capacitive component that comprises a parallel circuit having a number of capacitances that are connected in parallel and that are adapted to be activated or deactivated independently of each other, the parallel circuit being connected in parallel with one of the first or second windings.

6. The circuit arrangement according to claim 5, further comprising an activation element connected in series to at least one of the capacitances.

7. The circuit arrangement according to claim 6, wherein the at least one of the variable inductive component and/or variable capacitive component is adapted to receive a control signal that adjusts one of an inductance value and/or a capacitance value.

8. The circuit arrangement according to claim 7, wherein the trimming device comprises a control circuit for providing a control signal.

9. The circuit arrangement according to claim 8, wherein the control circuit comprises a programmable circuit.

10. The circuit arrangement according to claim 8, wherein the control circuit is adapted to receive a load characteristic signal and is adapted to provide the control signal dependent on the load characteristic signal.

11. The circuit arrangement according to claim 10, further comprising:
an evaluation circuit that is adapted to evaluate a parameter and generate a load characteristic signal dependent on the evaluated parameter, the parameter comprising one of input power of the circuit arrangement; input impedance of the circuit arrangement; output power of the circuit arrangement; or output impedance of the circuit arrangement.

12. A method for signal or power transmission through a circuit arrangement that comprises:
input terminals;
a coreless transformer having a first winding and a second winding;
a trimming device that is connected to one of the first and second windings and that includes at least one of a variable capacitive component and/or a variable inductive component, the variable capacitive component having an adjustable capacitance and the variable inductive component having an adjustable inductance;
the circuit arrangement having a maximum efficiency frequency (MEF) and a maximum impedance frequency (MIF) that is dependent on one of capacitance and inductance;
the method comprising:
applying an input signal that has an input frequency to the input terminals;
adjusting one of the MEF and MIF of the circuit arrangement differ from the input frequency by less than a given frequency difference by adjusting at least one of the adjustable capacitance and the adjustable inductance.

13. The method according to claim 12, wherein the frequency difference is less than 10% of the input frequency.

14. The method according to claim 12, wherein the frequency difference is less than 5% of the input frequency.

15. The method according to claim 12, wherein the frequency difference is substantially zero.

16. The method according to claim 12, wherein the one of the MEF and MIF of the circuit arrangement is adjusted during operation of the circuit arrangement.

17. The method according to claim 16, further comprising:
evaluating a parameter selected from the group consisting of: an input power of the circuit arrangement; an input impedance of the circuit arrangement; an output power of the circuit arrangement, and; an output impedance of the circuit arrangement; and
adjusting the at least one of the adjustable capacity and adjustable inductivity dependent on the evaluated parameter.
